(19) United States
(12) Patent Application Publication
(10) Pub. No.: US 2025/0177905 A1
(43) Pub. Date: Jun. 5, 2025

(54) CARBON DIOXIDE CAPTURE SYSTEM BASED ON PHASE CHANGE ABSORBENT

(71) Applicant: Tsinghua University, Beijing (CN)

(72) Inventors: Zhen Chen, Beijing (CN); Junhua Li, Beijing (CN); Guoxiong Zhan, Beijing (CN)

(21) Appl. No.: 18/844,281

(22) PCT Filed: Sep. 20, 2022
(86) PCT No.: PCT/CN2022/119936

§ 371 Date: Sep. 5, 2024

(30) Foreign Application Priority Data
Mar. 9, 2022 (CN) 202210224992.0

(51) Int. Cl. B01D 53/14; B01D 53/18; B01F 27/1143; B01F 27/1144; B01F 27/72; B01F 101/00

(52) U.S. Cl. CPC B01D 53/1425; B01D 53/1475; B01D 53/18; B01F 27/1143; B01F 27/1144; B01F 27/72; B01D 2252/204; B01D 2252/30; B01D 2257/504; B01D 2258/0283; B01F 2101/2204

(57) ABSTRACT

Provided is a carbon dioxide capture system based on a biphasic solvent, the system comprising an absorption tower, a phase splitter, a first law power device, a heat exchange regenerator, a heat pump, and a plurality of second law power devices. The heat exchange regenerator comprises a gas discharge port for discharging carbon dioxide desorbed in the heat exchange regenerator.

### CROSS-REFERENCE TO RELATED APPLICATION

The present disclosure claims the benefit of a priority of a previous invention patent application No. 202210224992.0, filed in China on Mar. 9, 2022 and entitled “CARBON DIOXIDE CAPTURE SYSTEM BASED ON BIPHASIC SOLVENT”, the entire contents of which are incorporated herein by reference.

### TECHNICAL FIELD

The present disclosure relates to the technical field of carbon dioxide capture, in particular to a carbon dioxide capture system based on a biphasic solvent.

### BACKGROUND

Under the circumstance of sustainable development, global carbon emissions need to be reduced from 42 billion tons in 2019 to 10 billion or less tons in 2050, and achieve net zero emission in 2070. Among the numerous carbon dioxide emission reduction technologies, the chemical absorption method based on organic amine solution has been used commercially. At present, the main problem facing the chemical absorption method based on organic amine solution is that the energy consumption in the process of desorption of carbon dioxide is too high, which leads to high cost of carbon dioxide capture.

Specifically, the conventional organic amine method is to make flue gas containing a certain concentration of carbon dioxide, after entering an absorption tower, react with organic amine serving as an absorbent to generate carbamate, and at the same time, an absorbent solution becomes a rich solution. The rich solution is discharged from a bottom of the absorption tower, and enters a desorption tower after heat exchange, where the carbon dioxide is desorbed and the absorbent is regenerated under certain temperature and pressure conditions. The regenerated absorbent returns to the absorption tower after heat exchange and continues to absorb carbon dioxide in the flue gas. During the desorption process, due to the strong bonding between the organic amine absorbent and the carbon dioxide molecules, a large amount of water vapor is required to separate the absorbent from the carbon dioxide and become a regenerated absorbent. That is to say, in the carbon dioxide capture system based on the conventional organic amine method, the energy consumption of the absorbent's regeneration is too high.

In recent years, in order to reduce the high regeneration energy consumption during the desorption process, it has been proposed a method of making phase splitting of the absorbent using a biphasic solvent and concentrating the carbon dioxide. Taking a specific liquid-liquid biphasic solvent as an example, after absorbing carbon dioxide, due to the increase in the molecular polarity difference between the products, a lean phase in the upper layer and a rich phase in the lower layer will be formed. Carbon dioxide is mainly concentrated in the rich phase in the lower layer. Under the condition of having same carbon dioxide contents, the rich-phase solvent in the lower layer has a higher viscosity and a smaller volume, resulting in lower regeneration energy consumption. However, if a biphasic solvent is used to absorb carbon dioxide in the existing carbon dioxide capture system, the following problem will arise: after the rich-phase solvent is heated by a heat exchange device between the absorption tower and the desorption tower, its viscosity decreases and its volume increases, resulting in increased regeneration energy consumption. Therefore, it is urgent to develop a carbon dioxide capture system suitable for biphasic solvent.

### SUMMARY

The present disclosure is made in view of the state of the prior art described above. An object of the present disclosure is to provide a carbon dioxide capture system based on a biphasic solvent. The system can make full use of the advantage of the low energy consumption of the rich-phase solvent to reduce the cost of carbon dioxide capture. And the system can increase the carbon dioxide absorption capacity of the regenerated absorbent while reducing energy consumption in the heat exchange flow path.

There is provided a carbon dioxide capture system based on a biphasic solvent, comprising an absorption tower, a phase separator, a first type of power device, a heat exchange regenerator, a heat pump, and a plurality of second type of power devices,
wherein a mixed absorbent outlet of the absorption tower is connected to an absorbent inlet of the phase separator via one of the second type of power devices, and a lean-phase solvent outlet of the phase separator is connected to a mixed absorbent inlet of the absorption tower via one of the second type of power devices,
a rich-phase solvent outlet of the phase separator is connected to a rich-phase solvent inlet of the heat exchange regenerator via the first type of power device, a regenerated absorbent outlet of the heat exchange regenerator is connected to a first inlet of the heat pump, and a first outlet of the heat pump is connected to the mixed absorbent inlet of the absorption tower,
a heat exchange medium outlet of the heat exchange regenerator is connected to a second inlet of the heat pump, and a second outlet of the heat pump is connected to a heat exchange medium inlet of the heat exchange regenerator via one of the second type of power devices, and
the heat exchange regenerator comprises a gas discharge port for discharging carbon dioxide desorbed in the heat exchange regenerator.

In at least one embodiment, the carbon dioxide capture system comprises a plurality of the heat exchange regenerators, which are arranged in parallel in a flow path from the second type of power device connected to the second outlet of the heat pump towards the heat pump.

In at least one embodiment, a heater is provided in a flow path from the heat pump towards the heat exchange regenerator.

In at least one embodiment, the carbon dioxide capture system further comprises an absorbent replenishing device, which is connected to the mixed absorbent inlet of the absorption tower and is configured to replenish the biphasic solvent.

In at least one embodiment, the first type of power device is a pipeline centrifugal pump, a diaphragm pump or a gear pump.

In at least one embodiment, a viscosity of the rich-phase solvent flowing out of the rich-phase solvent outlet of the phase separator is lower than 100 mPa·s, and the first type of power device is a pipeline centrifugal pump, or
a viscosity of the rich-phase solvent flowing out of the rich-phase solvent outlet of the phase separator is in a range of 100 to 5000 mPa·s, and the first type of power device is a diaphragm pump, or
a viscosity of the rich-phase solvent flowing out of the rich-phase solvent outlet of the phase separator is higher than 5000 mPa·s, and the first type of power device is a gear pump.

In at least one embodiment, a heat-retaining layer is provided in a flow path from the phase separator towards the heat exchange regenerator.

In at least one embodiment, the biphasic solvent is one of a composite organic amine biphasic solvent, a biphasic solvent composed of an organic amine and a physical solvent, and a biphasic solvent composed of a composite amine and an ionic liquid.

In at least one embodiment, the heat exchange regenerator comprises a heat exchange device and a driving device,

wherein the rich-phase solvent inlet is provided on one side of a housing of the heat exchange device in a longitudinal direction, and the regenerated absorbent outlet and the gas discharge port are provided on the other side of the housing of the heat exchange device in the longitudinal direction.

In at least one embodiment, a blade for stirring the absorbent and a screw through which the heat exchange medium passes are provided inside the heat exchange device,

wherein the blade is fixedly connected to the screw, the screw is connected to the driving device and is rotatable, the heat exchange medium inlet is located at one end of the screw, and the heat exchange medium outlet is located at the other end of the screw.

By adopting the above technical solution, the advantage of low energy consumption of the rich-phase solvent can be fully utilized to reduce the cost of carbon dioxide capture, and the carbon dioxide absorption capacity of the regenerated absorbent can be increased while reducing energy consumption in the heat exchange flow path.

### BRIEF DESCRIPTION OF THE DRAWINGS

FIG. 1 shows a schematic diagram of a carbon dioxide capture system including one heat exchange regenerator according to the present disclosure.

FIG. 2 shows a schematic diagram of a carbon dioxide capture system including two heat exchange regenerators according to the present disclosure.

FIG. 3 shows a schematic structural diagram of a heat exchange regenerator according to the present disclosure.

### DETAILED DESCRIPTION

Exemplary embodiments of the present disclosure are described below with reference to the accompanying drawings. It is appreciated that these specific descriptions are intended only to teach a person skilled in the art how to implement the present disclosure, and are not intended to exhaust all possible ways in which the present disclosure could be implemented, nor are they intended to limit the scope of the present disclosure.

The technical ideas of the present disclosure are summarized below. The present disclosure proposes a carbon dioxide capture system based on a biphasic solvent. The system replaces a desorption tower in a conventional carbon dioxide capture system with a heat exchange regenerator. When a biphasic solvent is used, the viscosity of the rich-phase solvent is not reduced prior to desorption, and thus regeneration and recycling of the biphasic solvent is achieved with lower regeneration energy consumption.

In particular, in the present embodiment, the biphasic solvent is one of a composite organic amine biphasic solvent, a biphasic solvent composed of an organic amine and a physical solvent, and a biphasic solvent composed of a composite amine and an ionic liquid, and has the property of stratifying according to the concentration of carbon dioxide after absorbing carbon dioxide. In addition, the heat exchange medium may be one of a gas phase medium and a liquid phase medium, wherein the gas phase medium may be water vapor, carbon dioxide, etc., and the liquid phase medium may be water, heat conduction oil, etc.

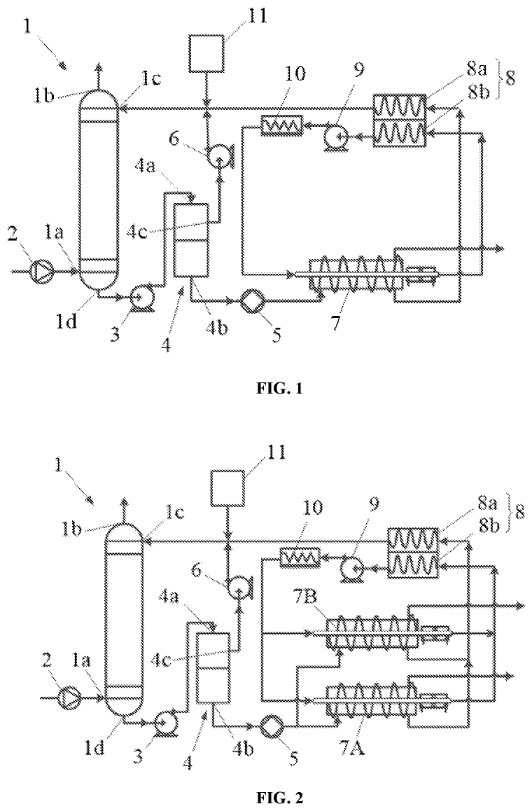

As shown in FIG. 1, the carbon dioxide capture system based on a biphasic solvent according to the present embodiment may comprise a carbon dioxide capture flow path through which the biphasic solvent flows and a heat exchange flow path through which a heat exchange medium flows. The carbon dioxide capture flow path may comprise an absorption tower 1, a phase separator 4, a heat exchange regenerator 7, a heat pump 8, and pumps for promoting the flow of the biphasic solvent. In the heat exchange flow path, it may comprise a heat exchange regenerator 7, a heat pump 8, a heater 10, and a pump for promoting the flow of the heat exchange medium.

In this embodiment, carbon dioxide is desorbed by causing the rich-phase solvent in the carbon dioxide capture flow path to exchange heat with the heat exchange medium in the heat exchange flow path in the heat exchange regenerator 7, and furthermore, by causing the regenerated absorbent in the carbon dioxide capture flow path to exchange heat with the heat exchange medium in the heat exchange flow path in the heat pump 8, energy consumption in the heat exchange flow path is reduced and the carbon dioxide absorption capacity of the absorbent which returns to the absorption tower 1 is increased.

Hereinafter, various members constituting the carbon dioxide capture system of the present disclosure will be described.

The absorption tower 1 is a device for removing carbon dioxide from flue gas. The absorption tower 1 may comprise a flue gas inlet 1a, a flue gas outlet 1b, a mixed absorbent inlet 1c, and a mixed absorbent outlet 1d. The flue gas inlet 1a is located at the bottom of the absorption tower 1 to allow inflow of flue gas. The flue gas outlet 1b is located at the top of the absorption tower 1 to allow outflow of flue gas. The mixed absorbent inlet 1c is located in the vicinity of the flue gas outlet 1b and is configured to allow inflow of a second mixed absorbent, the second mixed absorbent being mixed with the lean-phase solvent in the upper layer, the regenerated absorbent, and a new biphasic solvent described later. The mixed absorbent outlet 1d is located in the vicinity of the flue gas inlet 1a and is configured to discharge a mixed liquid of the biphasic solvent that has absorbed carbon dioxide, that is, a first mixed absorbent. It is appreciated that the carbon dioxide content of the first mixed absorbent is much greater than the carbon dioxide content of the second mixed absorbent.

In the absorption tower 1, the second mixed absorbent flows from the top to the bottom of the absorption tower 1, and the flue gas flows from the bottom to the top of the absorption tower 1. Thus, the flue gas flowing into the absorption tower 1 is brought into counterflow contact with the second mixed absorbent sufficiently, and the second mixed absorbent absorbs carbon dioxide in the flue gas to become the first mixed absorbent which flows out of the mixed absorbent outlet 1d. Here, the absorption rate of carbon dioxide is highest when the reaction temperature in the absorption tower 1 is between 40° C. and 70° C.

The phase separator 4 is a device for stratifying the first mixed absorbent. The phase separator 4 comprises an absorbent inlet 4a at the top, a rich-phase solvent outlet 4b at the bottom, and a lean-phase solvent outlet 4c in a lean-phase region in the upper layer.

In the phase separator 4, the first mixed absorbent will stratify after standing for a period of time due to the large difference in molecular polarity between the components of the first mixed absorbent. The upper layer is a lean phase with relatively low viscosity, and the lower layer is a rich phase with relatively high viscosity. 95% or more of the carbon dioxide is concentrated in the rich phase in the lower layer. In particular, in order to maintain the respective heights of the lean-phase region and the rich-phase region in the phase separator 4 unchanged, the generation rate of the lean phase may be equal to the discharge rate of the lean phase, the generation rate of the rich phase may be equal to the discharge rate of the rich phase, and the absorbent inflow rate of the phase separator 4 may be equal to the sum of the discharge rates of the lean phase and the rich phase.

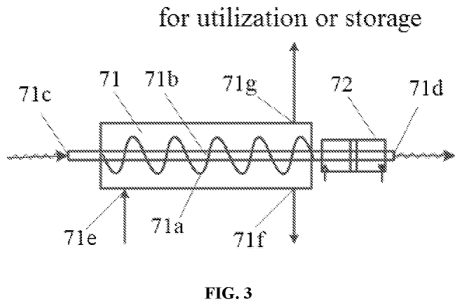

Referring to FIGS. 1 and 3, the heat exchange regenerator 7 is a device for desorbing carbon dioxide. The heat exchange regenerator 7 may comprise a heat exchange device 71 and a driving device 72. The heat exchange device 71 may comprise a blade 71a, a screw 71b, a heat exchange medium inlet 71c, a heat exchange medium outlet 71d, a rich-phase solvent inlet 71e, a regenerated absorbent outlet 71f, and a gas discharge port 71g. The rich-phase solvent inlet 71e is provided on one side of the heat exchange device 71 in the longitudinal direction, and the regenerated absorbent outlet 71f is provided on the other side of the heat exchange device 71 in the longitudinal direction. The screw 71b has a hollow structure, which runs through the heat exchange device 71 and is connected to the driving device 72. The heat exchange medium inlet 71c is provided at one end of the screw 71b close to the rich-phase solvent inlet 71e, and the heat exchange medium outlet 71d is provided at one end of the screw 71b close to the regenerated absorbent outlet 71f. Inside the heat exchange device 71, a blade 71a for stirring the absorbent is provided on the screw 71b. The driving device 72 is connected to the screw 71b. Here, the blade 71a may be a fin or a rib.

During the desorption process, the driving device 72 drives the screw 71b to rotate, so that the screw 71b causes the blade 71a to rotate, thereby stirring the absorbent flowing into the heat exchange device 71. Thus, sufficient heat exchange may be performed between the first mixed absorbent with a relatively low temperature which flows into the heat exchange device 71 and the heat exchange medium with a relatively high temperature which flows into the screw 71b.

The heat pump 8 is a mechanical device that forces heat to flow from a low-temperature object to a high-temperature object. The heat pump 8 comprises a compressor (not shown) which may heat and pressurize a low-temperature and low-pressure liquid flowing into the interior. The heat pump 8 comprises a first heat exchanger 8a and a second heat exchanger 8b. The first heat exchanger 8a comprises a first inlet for inflow of the regenerated absorbent and a first outlet for outflow of the regenerated absorbent, and the second heat exchanger 8b comprises a second inlet for inflow of the heat exchange medium and a second outlet for outflow of the heat exchange medium.

Hereinafter, the flow paths of the carbon dioxide capture system according to the present disclosure will be described in detail.

### (Carbon Dioxide Capture Flow Path)

A blower 2 is provided in the vicinity of the flue gas inlet 1a and is configured to blow the flue gas containing carbon dioxide towards the absorption tower 1. The mixed absorbent outlet 1d of the absorption tower 1 is connected to the inlet of the second type of power device (i.e., the mixed absorbent pump 3). The outlet of the mixed absorbent pump 3 is connected to the absorbent inlet 4a of the phase separator 4.

The rich-phase solvent outlet 4b at the bottom of the phase separator 4 is connected to the inlet of the first type of power device (i.e., a rich-phase pump 5 for the lower layer). The outlet of the rich-phase pump 5 for the lower layer is connected to the rich-phase solvent inlet 71e of the heat exchange regenerator 7. The regenerated absorbent outlet 71f of the heat exchange regenerator 7 is connected to the first inlet of the first heat exchanger 8a of the heat pump 8. The first outlet of the first heat exchanger 8a of the heat pump 8 is connected to the mixed absorbent inlet 1c of the absorption tower 1. The absorbent replenishing device 11 is connected to the mixed absorbent inlet 1c of the absorption tower 1 and configured to replenish a new biphasic solvent. Here, the temperature of the new biphasic solvent may be room temperature.

The lean-phase solvent outlet 4c in the upper layer region of the phase separator 4 is connected to the inlet of the second type of power device (i.e., a lean-phase pump 6 for the upper layer). The outlet of the lean-phase pump 6 for the upper layer is connected to the mixed absorbent inlet 1c of the absorption tower 1.

In particular, in the present embodiment, the rich-phase solvent flowing out of the rich-phase solvent outlet 4b has a very high viscosity and thus is difficult to transport. Therefore, the type of the rich-phase pump 5 for the lower layer may be selected based on the viscosity of the rich-phase solvent when setting the operating temperature, to ensure that the rich-phase solvent may be transported to the heat exchange regenerator 7 via the rich-phase pump 5 for the lower layer. For example, when the viscosity of the rich-phase solvent is lower than 100 mPa·s, a pipeline centrifugal pump may be used. When the viscosity of the rich-phase solvent is in a range of 100 to 5000 mPa·s, a diaphragm pump may be used. When the viscosity of the rich-phase solvent is higher than 5000 mPa·s, a gear pump may be used.

In addition, since the temperature of the rich-phase solvent flowing out of the phase separator 4 is higher than the external temperature, the temperature of the rich-phase solvent flowing in a pipeline from the phase separator 4 towards the heat exchange regenerator 7 may decrease, and consequently the viscosity may further increase. Therefore, in the present embodiment, preferably, a heat-retaining layer is provided on the outer surface of the pipeline from the phase separator 4 towards the heat exchange regenerator 7, so as to ensure that the viscosity of the rich-phase solvent in the pipeline remains unchanged. The rich-phase solvent may be transported to the heat exchange regenerator 7 by a selected pump.

Furthermore, if the pipeline from the phase separator 4 towards the heat exchange regenerator 7 is too long, the high-viscosity rich-phase solvent in the pipeline is difficult to be transported to the heat exchange regenerator 7 under the action of the rich-phase pump 5 for the lower layer. Therefore, in the present embodiment, preferably, the pipeline from the phase separator 4 towards the heat exchange regenerator 7 is designed to be short.

### (Heat Exchange Flow Path)

The heat exchange medium outlet 71d of the heat exchange regenerator 7 is connected to a second inlet of the second heat exchanger 8b of the heat pump 8. A second outlet of the second heat exchanger 8b of the heat pump 8 is connected to the inlet of the second type of power device (i.e., a heat exchange medium pump 9). An outlet of the heat exchange medium pump 9 is connected to an inlet of the heater 10. An outlet of the heater 10 is connected to the heat exchange medium inlet 71c of the heat exchange regenerator 7.

The following describes the working process of the carbon dioxide capture system according to the present disclosure.

The flue gas enters the absorption tower 1 under the action of the blower 2, and flows from the bottom to the top of the absorption tower 1, and is discharged from the flue gas outlet 1b of the absorption tower 1 after being brought into counterflow contact with the second mixed absorbent of the absorption tower 1. The second mixed absorbent, after being brought into counterflow contact with the flue gas, becomes the first mixed absorbent containing a large amount of carbon dioxide, flowing out of the mixed absorbent outlet 1d of the absorption tower 1.

The first mixed absorbent flowing out of the mixed absorbent outlet 1d of the absorption tower 1 flows into the phase separator 4 under the action of the mixed absorbent pump 3. In the phase separator 4, the first mixed absorbent is left to stand for at least ten minutes, stratified into an upper layer of lean-phase solvent and a lower layer of rich-phase solvent. Therein, most of the carbon dioxide in the first mixed absorbent is concentrated in the rich-phase solvent in the lower layer. As a result, phase splitting of the mixed absorbent is achieved.

The rich-phase solvent in the lower layer of the phase separator 4 enters the interior of the heat exchange device 71 through the rich-phase solvent inlet 71e of the heat exchange device 71 under the action of the rich-phase pump 5 for the lower layer. At this time, the rich-phase solvent desorbs carbon dioxide under the action of the heat exchange medium with high temperature and becomes a regenerated absorbent with high temperature. Here, carbon dioxide is discharged through the gas discharge port 71g of the heat exchange device 71 and then utilized or stored, and the regenerated absorbent flows out of the regenerated absorbent outlet 71f of the heat exchange device 71. Thus, the regeneration of the rich-phase solvent is achieved.

Here, the temperature of the rich-phase solvent flowing into the heat exchange device 71 through the rich-phase solvent inlet 71e of the heat exchange device 71 may be in a range of 40° C. to 70° C. The temperature of the regenerated absorbent flowing out of the regenerated absorbent outlet 71f of the heat exchange device 71 may be in a range of 80° C. to 120° C. The temperature of the heat exchange medium flowing into the heat exchange device 71 through the heat exchange medium inlet 71c of the heat exchange device 71 may be in a range of 100° C. to 160° C. The temperature of the heat exchange medium flowing out of the heat exchange medium outlet 71d of the heat exchange device 71 may be in a range of 80° C. to 120° C. Specifically, the temperature of the heat exchange medium flowing out of the heat exchange medium outlet 71d of the heat exchange device 71 is higher than or equal to the temperature of the regenerated absorbent flowing out of the regenerated absorbent outlet 71f of the heat exchange device 71.

The regenerated absorbent flowing out of the regenerated absorbent outlet 71f of the heat exchange device 71 flows into the first inlet of the first heat exchanger 8a of the heat pump 8, works in the heat pump 8 and thus decreases in temperature, and then flows out of the first outlet of the first heat exchanger 8a of the heat pump 8. The regenerated absorbent having a relatively low temperature flowing out of the outlet of the first heat exchanger 8a of the heat pump 8 flows into the top of the absorption tower 1 through the mixed absorbent inlet 1c of the absorption tower 1, and further flows from the top to the bottom of the absorption tower 1. Thereby, it enables the circulation of the regenerated absorbent.

The lean-phase solvent in the upper layer of the phase separator 4 flows into the top of the absorption tower 1 through the mixed absorbent inlet 1c of the absorption tower 1 under the action of the lean-phase pump 6 for the upper layer, and flows from the top to the bottom of the absorption tower 1 together with the regenerated absorbent. Thereby, it enables the circulation of the lean-phase solvent.

Here, the absorbent replenishing device 11 may provide a fresh absorbent to the mixed absorbent inlet 1c of the absorption tower 1, thereby increasing the carbon dioxide absorption rate of the absorbent in the absorption tower 1. The fresh absorbent flows from the top to the bottom of the absorption tower 1 together with the regenerated absorbent and the lean-phase solvent.

In addition, the heat exchange medium with high temperature discharged through the outlet of the heater 10 flows into the interior of the screw 71b through the heat exchange medium inlet 71c of the heat exchange device 71, and its temperature is lowered after heat exchange with the rich-phase solvent in the heat exchange device 71. The heat exchange medium with the decreased temperature flows out of the heat exchange medium outlet 71d of the heat exchange device 71. The heat exchange medium flowing out of the heat exchange medium outlet 71d of the heat exchange device 71 flows into the second heat exchanger 8b of the heat pump 8, and its temperature rises after receiving the thermal energy from the first heat exchanger 8a. The heat exchange medium with the increased temperature flows out of the second outlet of the second heat exchanger 8b of the heat pump 8 and flows into the heater 10 where it is heated. The heat exchange medium after being heated flows again into the interior of the screw 71b of the heat exchange device 71. Thereby, circulation of the heat exchange medium is achieved. Here, the heater 10 may be driven by steam heat exchange or by electric heating.

Here, the temperature of the regenerated absorbent flowing into the first heat exchanger 8a through the first inlet of the first heat exchanger 8a may be in a range of 80° C. to 120° C. The temperature of the regenerated absorbent flowing out of the first outlet of the first heat exchanger 8a may be in a range of 40° C. to 60° C. The temperature of the heat exchange medium flowing into the second heat exchanger 8b through the second inlet of the second heat exchanger 8b may be in a range of 80° C. to 120° C. The temperature of the heat exchange medium flowing out of the second outlet of the second heat exchanger 8b may be in a range of 100° C. to 140° C. That is, the temperature difference between the heat exchange medium and the regenerated absorbent flowing out of the heat exchange regenerator 7 is further increased in the heat pump 8.

According to the carbon dioxide capture system based on a biphasic solvent as described above, the following effects can be achieved.

(1) Compared with the conventional carbon dioxide capture system, the present disclosure adopts a heat exchange regenerator 7 to replace the conventional desorption packed tower. In other words, unlike the conventional carbon dioxide capture system in which the absorbent is first heated by a heat exchanger and then enters a desorption tower for regenerating, the present disclosure is able to simultaneously carry out the heating and desorbing of the absorbent in the heat exchange regenerator 7. Therefore, in the carbon dioxide capture system according to the present disclosure, the rich-phase solvent is desorbing in a concentrated state with a high viscosity, so that the advantage of low energy consumption of the rich-phase solvent can be brought into full play and the cost of carbon dioxide capture can be reduced.

(2) Compared with the conventional carbon dioxide capture system, the present disclosure uses a heat pump to replace the heat exchanger. In the present embodiment, the temperature of the heat exchange medium flowing out of the heat exchange medium outlet 71d of the heat exchange device is higher than the temperature of the regenerated absorbent flowing out of the regenerated absorbent outlet 71f of the heat exchange device. Further, the working in the heat pump 8 results in a higher temperature of the heat exchange medium and a lower temperature of the regenerated absorbent which is to be returned to the absorption tower 1. As a result, the energy consumption in the heat exchange flow path is reduced and the carbon dioxide absorption capacity of the regenerated absorbent is increased.

(3) In the present embodiment, the heat exchange regenerator may comprise a screw, a blade, and a driving device for driving the screw to rotate, which may increase the heat exchange area and efficiently conduct heat.

It will be appreciated that in the present disclosure, when the number of parts or members is not specifically defined, the number may be one or more, with the “more” here means greater than or equal to two. For cases where the drawings show and/or the description specifies the number of parts or members as a specific number of, e.g., two, three, or four, the specific number is generally exemplary rather than limiting, and may be construed as a plurality of, i.e., two or greater than two, but this does not mean that the present disclosure excludes the case of a single one.

It is appreciated that the above embodiments are merely exemplary and are not intended to limit the present disclosure. Various variations and changes to the above embodiments may be made by a person skilled in the art under the teachings of the present disclosure without departing from the scope of the present disclosure.

(i) For example, although the number of the heat exchange regenerator is one in the present embodiment, the present disclosure is not limited thereto. When a large amount of flue gas flows into the absorption tower 1, a plurality of heat exchange regenerators may be provided as needed. For example, as shown in FIG. 2, the carbon dioxide capture system is provided with the first heat exchange regenerator 7A and the second heat exchange regenerator 7B connected in parallel. Specifically, the heat exchange medium flowing out of the phase separator 4 flows into the first heat exchange regenerator 7A and the second heat exchange regenerator 7B through the rich-phase pump 5 for the lower layer, respectively, and then flows out to the first heat exchanger 8a of the heat pump 8, and the heat exchange medium flowing out of the heater 10 flows into the first heat exchange regenerator 7A and the second heat exchange regenerator 7B, respectively, and then flows out to the second heat exchanger 8b of the heat pump 8.

(ii) For example, although the absorbent replenishing device 11 is provided in the present embodiment, the present disclosure is not limited thereto, that is, the absorbent replenishing device 11 may not be provided.

(iii) For example, although the heater 10 is provided in the present embodiment, the present disclosure is not limited thereto. When the temperature of the heat exchange medium flowing out of the heat exchange medium pump 9 is high enough, the heater 10 may not be provided.

(iv) For example, although the heat exchange regenerator 7 has a structure comprising the screw 71b, the blade 71a, and the driving device 72 in the present embodiment, the present disclosure is not limited thereto. The heat exchange regenerator 7 may also be a plate heat exchanger or the like, as long as it is able to perform heat exchange between the heat exchange medium and the absorbent.

1. A carbon dioxide capture system based on a biphasic solvent, comprising an absorption tower, a phase separator, a first type of power device, a heat exchange regenerator, a heat pump, and a plurality of second type of power devices,
a mixed absorbent outlet of the absorption tower being connected to an absorbent inlet of the phase separator via one of the second type of power devices, a lean-phase solvent outlet of the phase separator being connected to a mixed absorbent inlet of the absorption tower via one of the second type of power devices,
a rich-phase solvent outlet of the phase separator being connected to a rich-phase solvent inlet of the heat exchange regenerator via the first type of power device, a regenerated absorbent outlet of the heat exchange regenerator being connected to a first inlet of the heat pump, a first outlet of the heat pump being connected to the mixed absorbent inlet of the absorption tower,
a heat exchange medium outlet of the heat exchange regenerator being connected to a second inlet of the heat pump, a second outlet of the heat pump being connected to a heat exchange medium inlet of the heat exchange regenerator via one of the second type of power devices, and
the heat exchange regenerator comprising a gas discharge port for discharging carbon dioxide desorbed in the heat exchange regenerator.

2. The carbon dioxide capture system based on a biphasic solvent according to claim 1, wherein the carbon dioxide capture system comprises a plurality of heat exchange regenerators, the plurality of heat exchange regenerators being provided in parallel connection in a flow path from the second type of power device connected to the second outlet of the heat pump towards the heat pump.

3. The carbon dioxide capture system based on a biphasic solvent according to claim 2, wherein a heater is provided in a flow path from the heat pump towards the heat exchange regenerator.

4. The carbon dioxide capture system based on a biphasic solvent according to claim 1, wherein the carbon dioxide capture system further comprises an absorbent replenishing device, the absorbent replenishing device being connected to the mixed absorbent inlet of the absorption tower and being configured to replenish the biphasic solvent.

5. The carbon dioxide capture system based on a biphasic solvent according to claim 1, wherein the first type of power device is a pipeline centrifugal pump, a diaphragm pump or a gear pump.

6. The carbon dioxide capture system based on a biphasic solvent according to claim 5, wherein a viscosity of a rich-phase solvent flowing out of the rich-phase solvent outlet of the phase separator is lower than 100 mPa·s, and the first type of power device is the pipeline centrifugal pump, or
a viscosity of the rich-phase solvent flowing out of the rich-phase solvent outlet of the phase separator is in a range of 100 to 5000 mPa·s, and the first type of power device is the diaphragm pump, or
a viscosity of the rich-phase solvent flowing out of the rich-phase solvent outlet of the phase separator is higher than 5000 mPa·s, and the first type of power device is the gear pump.

7. The carbon dioxide capture system based on a biphasic solvent according to claim 1, wherein a heat-retaining layer is provided in a flow path from the phase separator towards the heat exchange regenerator.

8. The carbon dioxide capture system based on a biphasic solvent according to claim 1, wherein the biphasic solvent is one of a composite organic amine biphasic solvent, a biphasic solvent composed of an organic amine and a physical solvent, and a biphasic solvent composed of a composite amine and an ionic liquid.

9. The carbon dioxide capture system based on a biphasic solvent according to claim 1, wherein the heat exchange regenerator comprises a heat exchange device and a driving device, and
the rich-phase solvent inlet is provided on one side of a housing of the heat exchange device in a longitudinal direction, and the regenerated absorbent outlet and the gas discharge port are provided on the other side of the housing of the heat exchange device in the longitudinal direction.

10. The carbon dioxide capture system based on a biphasic solvent according to claim 9, wherein a blade for stirring the absorbent and a screw through which the heat exchange medium passes are provided inside the heat exchange device,
the blade being fixedly connected to the screw, the screw being connected to the driving device and being rotatable, the heat exchange medium inlet being located at one end of the screw, and the heat exchange medium outlet being located at the other end of the screw.
